(19) United States
(12) Patent Application Publication
(10) Pub. No.: US 2002/0102127 A1
(43) Pub. Date: Aug. 1, 2002

(54) Linear connector of plastic material for joining hollow spacing profiles and hollow bar profiles of multiple insulating glasses

(76) Inventor: Walter Loh, Kaufbeuren-Neugablonz (DE)

Correspondence Address: Ernest Gifford, Suite 400, 280 N. Woodward Avenue, Birmingham, MI, 48009, US

(21) Appl. No.: 10/055,592

(22) Filed: Jan. 23, 2002

(30) Foreign Application Priority Data
Jan. 29, 2001 (DE) 201 01 486.6

(51) Int. Cl. F16B 7/00; F16B 12/36; F16B 13/00

(52) U.S. Cl. 403/292

(57) ABSTRACT

Linear connector of plastic material for joining hollow spacing profiles A, B and hollow bar profiles of a multiple insulating glass, comprising a flat, longitudinal body which is to be inserted with its one end into the spacing profile A and with its other end into the spacing profile B, the surfaces of which are provided with an abutment element positioned in the center of the linear connector, which abutment element touches the front faces C and D of the spacing profiles on insertion of the linear connector into the spacing profiles which are to be connected to one another, wherein the mentioned longitudinal body comprises a double-T-cross-section the distantly parallel and horizontal crossbars of which being connected by at least one vertical center bar and contacted at least partly in the mounted condition of the linear connector by the opposing surfaces of the inner wall of the spacing profiles.

In order to improve the sealing effect of the linear connector as well a its seat within the hollow spaces of the metallic spacing profiles which are to be connected to one another and to avoid that the gap between the spacing profile bodies arises after mounting the linear connector it is proposed that that at least one of the two cross-bars of the double-T-cross-section is provided in the center of its length with a recess making visible the surfaces of the spacing profiles in their mounted condition within the area of their ends comprising the front faces of the spacing profiles positioned opposite to one another so that welding of these ends by heat treatment is possible without melting the plastic material of the linear connector.

### BACKGROUND OF THE INVENTION

The invention concerns a linear connector of plastic material for joining hollow spacing profiles A, B and hollow bar profiles of multiple insulating glasses, comprising a flat longitudinal body of which its one end is insertable into the one spacing profile A and its other end is insertable into the other spacing profile B which are to be connected to one another. The surface of the body is provided with at least one abutment element in the center of the linear connector which on the insertion of the linear connector into the spacing profiles to be connected to one another is abutting the profile front faces C, D respectively. The longitudinal body is provided with a double-T-cross-section with distantly parallel and horizontal cross bars which are joined by at least one vertical center bar and at least partly touch in the mounted condition of the linear connector the opposing surfaces of the inner wall of the profiles.

Linear connectors of such a kind are for instance known from EP 0 681 083 having a cross section configuration adapted to the cross-section of the hollow spacing profiles which are to be connected to one another. Such a kind of linear connectors are generally configurated such that the hollow profiles are hold together within the abutment area after mounting. There are certain cases, however, in which the demands upon the connection of the hollow profiles are not sufficiently fulfilled by the known linear connectors, because the connection force of these known elements is only based on frictional forces between the surfaces of the linear connector and the surfaces of the inner walls of the spacing profiles.

### SUMMARY OF THE INVENTION

It is therefore an object of the invention to develop the linear connector of the above mentioned kind further in order to improve the sealing effect between the body of the linear connector at the joining gap and the bodies of the spacing profiles which are to be joined.

In this connection it is a further object of the invention to improve the joining forces of the hollow profiles of the mounting of the linear connector.

According to a still further object of the invention it is intended to further improve the durability of the joint of linear connectors and spacing profiles and bar profiles as part of multiple insulating glass units.

In this connection it has also been proposed to join such a kind of hollow spacing profiles at their abutting faces by welding, if the spacing profiles are of metal. In such cases, however, the linear connector of plastic material should not be destroyed by the influence of the heat during the welding process.

Thus, it is a still further object of the invention to configure the linear connector such that damages of the linear connector are avoided without obstructing, however, the welding process and the formation of the requested welding seam.

These and other objects of the invention are solved by a construction characterized in that at least one of the two cross-bars is provided in the center of its length with a recess making visible the surface of the spacing profiles in the joined condition within the area of their ends provided with the front faces of the spacing profiles connected to one another, which recess enables welding of these ends under heat without melting the plastic material of the linear connector.

In this connection it is especially advantageous to configure the provided recess such that the strength of the linear connector being directly dependent on the cross-section configuration of the connector will not be affected negatively so that the connector cannot fulfill its function. Therefore, in general the one cross-bar is recessed in the joining area so that the metallic surfaces of the spacing profiles which in general consist of aluminum, become visible so that in this area a welding seam or welding point may be established closing also the gap between the front faces of the spacing profile bodies to be joined, resulting therein that the drying substance within the hollow space of the spacing profiles cannot leave the spacing profiles within the joining area.

Further advantageous embodiments of the invention are characterized by the subclaims and are described in connection with the drawings.

### DESCRIPTION OF THE DRAWINGS

A better understanding of the invention will be reached by reference to the following detailed description when read in conjunction with the accompanying drawings in which

FIG. 1 is a plan view of the linear connector,

FIG. 2 is a lateral view of the linear connector of FIG. 1,

FIG. 3 is a front view of the linear connector of FIG. 1, and

FIG. 4 is a longitudinal sectional view of the linear connector mounted inserted into the hollow spacing profiles.

### DESCRIPTION OF PREFERRED EMBODIMENTS

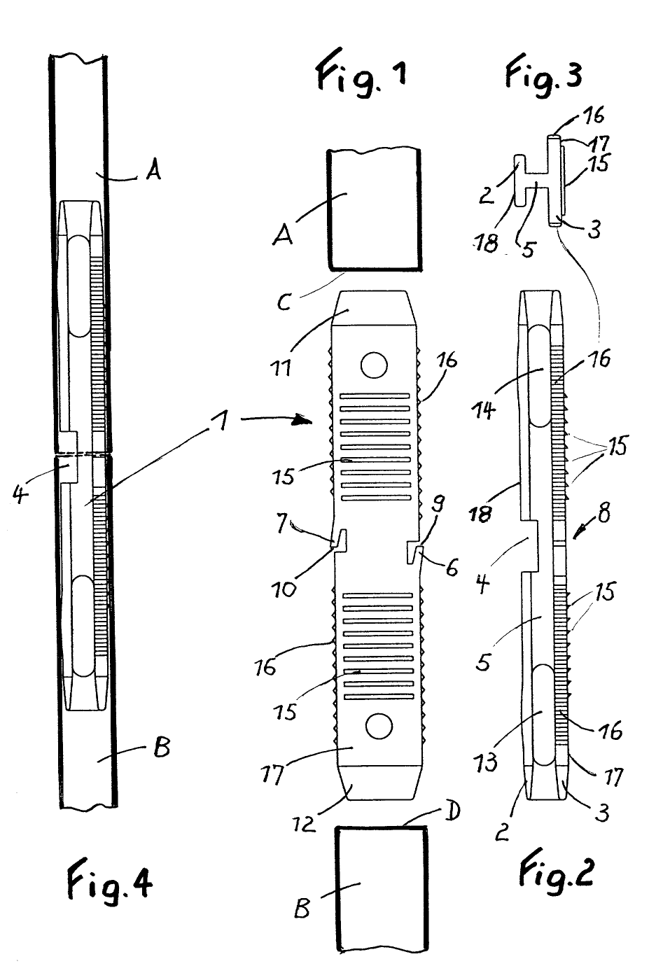

The linear connector 1 as shown in FIGS. 1-4 is provided with a flat, longitudinal body the one end 11 of which will be inserted into the one spacing profile A schematically shown in the drawings and the other end 12 will be inserted into the other spacing profile B which is also schematically shown, in order to connect these two spacing profiles also called hollow profiles to one another before the spacing profiles as usual will be laterally provided with the panes of the multiple insulating glass.

The linear connector comprises a well known double-T-cross-section provided with an upper horizontal cross-bar 2 and a lower horizontal cross-bar 3 which are differing in this example with respect to their width in order to adapt them to the cross-section of the spacing profiles and which are joined by a vertical or almost vertical center bar 5 provided with apertures 13 and 14 in order to save material but also to improve the throughput of the drying substance well known in the art.

On the surface 17 of the lower cross-bar 3 in the middle of the length of the linear connector a centric abutment element 8 is provided having the configuration of two laterally extending abutment tongues 6, 7. The one abutment tongue 6 is directed with its face or abutment surface 9 to the end 11 of the linear connector whereas the other abutment tongue 7 is directed with its face or abutment surface 10 to the other end 12 of the linear connector so that on shifting or inserting the spacing profiles A and B onto the linear connector the front faces C or D respectively contact the faces 9 and 10, respectively in order to avoid that the linear connector is inserted too far into the spacing profile. Instead of the above mentioned abutment elements other configurated or arranged abutment elements may also be used in this connection. As soon as mounting has been made as mentioned above the front faces C and D of the spacing profiles are in touch with one another at least partly.

In order to fix the linear connector within the hollow spaces of the spacing profiles A and B, it is provided on its surfaces with cross-ribs 15 and 16 known per se extending as shown by the FIGS. 1 and 2 across the direction of insertion and thus across the width of the linear connector. This is true with respect to the cross-ribs 15 on the horizontal surface of the linear connector as well as the much shorter bars 16 on both of the smaller side faces of the lower cross-bar 3. The frictional forces caused by these ribs together with the surfaces of the hollow spacing profiles touching them usually fix the linear connector within the mentioned hollow spaces and thus after the mounting in mounting condition without opening a gap between their front faces C and D.

In order to improve further the connection of the spacing profiles and especially to secure the connection under extreme conditions the metallic hollow spacing profiles A and B could be welded in the joining area without melting the mounted linear connector consisting of plastic material. For that purpose the upper cross-bar 2 is provided in its surface 18, about in the center of the linear connector with a recess 4 extending into the vertical center rib 5. This recess 4, however, is configured such that it does not weaken the cross-section of the linear connector in the stated area in a way which affects too much its strength. The recess 4 shows in mounting condition of the linear connector the spacing profiles A and B abutting at their front faces C and D so that welding of these profiles may be arranged in the abutting area, i.e. on one of the four surfaces of its rectangular profile. Thus, because of size and configuration of the recess 4 the recess 4 operates so that the plastic material of the linear connector does not melt on welding the metallic spacing profiles.

Instead of only one recess 4 several similar or different recesses may be used if necessary. In this connection it is basically possible to arrange the recess or recesses not only on one surface of the spacing profiles which are to be connected but also on further surfaces.

1. Linear connector of plastic material for joining hollow spacing profiles A, B and hollow bar profiles of a multiple insulating glass, comprising a flat, longitudinal body which is to be inserted with its one end into the spacing profile A and with its other end into the spacing profile B which are to be connected to one another, the surface of said body is provided with an abutment element positioned in the center of the linear connector, which abutment element touches the front faces C and D of the spacing profiles on insertion of the linear connector into the spacing profiles, wherein the mentioned longitudinal body comprises a double-T-cross-section, the distantly parallel and horizontal cross-bars of which being connected by at least one vertical center bar and contacted at least partly in mounted condition of the linear connector by the opposing surfaces of the inner walls of the spacing profiles, characterized in that at least one of the two cross-bars is provided in the center of its length with a recess making visible the surfaces of the metallic spacing profiles in the mounted condition of the connector within the area of their ends comprising the front faces of the spacing profiles positioned opposite to one another so that welding of these ends by heat treatment is possible without melting plastic material of the linear connector.

2. Linear connector according to claim 1, characterized in that the recess extends into the vertical center bar.

3. Linear connector according to claim 1, characterized in that the recess extends over the entire width of the cross-bar.

4. Linear connector according to claim 1, characterized in that the recess is rectangularly configurated.

5. Linear connector according to claim 1, characterized in that the width of the recess measured in direction of the width of the bar is smaller than its length measured between the ends of the linear connector.

6. Linear connector according to claim 1, characterized in that the recess is provided in the one cross-bar and the centric abutment element is provided in the other crossbar.

7. Linear connector according to claim 6, characterized in that the centric abutment element comprises two abutment tongues extending from the cross-bar, one of these tongues is directed with its front side face to the one end of the linear connector and the other tongue is directed with its front side face to the other end of the linear connector.
